(19) United States
(12) Patent Application Publication
(10) Pub. No.: US 2015/0372761 A1
(43) Pub. Date: Dec. 24, 2015

(54) PHOTOELECTRIC SENSOR WITH TONE MODULATION

(71) Applicant: Rockwell Automation Technologies, Inc., Mayfield Heights, OH (US)

(72) Inventor: Frederic Boutaud, Lexington, MA (US)

(21) Appl. No.: 14/312,247

(22) Filed: Jun. 23, 2014

(51) Int. Cl. H04B 10/516

(52) U.S. Cl. CPC H04B 10/516

(57) ABSTRACT

A photoelectric sensor comprises an emitter that generates a light beam modulated using a single-tone or multi-tone continuous wave signal (e.g., a sine wave, square wave, or triangular wave) rather than emitting a high-bandwidth pulsed light signal. Since the light beam is modulated using a single tone signal, the receiver is able to demodulate and evaluate the received optical signal within a narrow band around the fundamental frequency of the signal, thereby achieving greater noise rejection relative to light pulse modulation techniques, which require evaluation over a larger bandwidth. The photoelectric sensor also consumes relatively low power, since the single-tone signal requires less power to generate relative to light pulse modulation techniques.

### BACKGROUND

The subject matter disclosed herein relates generally to photoelectric sensors, and, more particularly, to a photoelectric sensor that modulates an optical signal using a single-tone or multi-tone continuous wave to reduce noise, reduce power consumption, and improve sensing performance and accuracy.

### BRIEF DESCRIPTION

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

In one or more embodiments, a photoelectric sensor is provided comprising a single-tone signal generator configured to modulate a light beam based on a single-tone continuous wave signal having a fundamental frequency, and a receiver configured to demodulate the light beam to yield a demodulated signal and to control an output based on detection of the fundamental frequency and its characteristics—such as amplitude and phase—in the demodulated signal.

A method for operating a photoelectric sensor is also described, wherein the method comprises modulating, by an emitter of a photoelectric sensor, a light beam with a single-tone continuous wave signal comprising a fundamental frequency; demodulating the light beam at a receiver of the photoelectric sensor to yield a demodulated signal; detecting, by a receiver of the photoelectric sensor, presence of the fundamental frequency in the demodulated signal; and controlling an output of the photoelectric sensor based on the detecting.

Also, in one or more embodiments, a system for optical detection of objects is provided, comprising means for generating a single-tone continuous wave signal comprising a fundamental frequency, means for modulating a light beam of an emitter of a photoelectric sensor using the single-tone continuous wave signal, means for demodulating the light beam at a receiver of the photoelectric sensor to yield a demodulated signal, and means for controlling an output of the photoelectric sensor based on detection of the fundamental frequency and its characteristics (e.g., amplitude and phase) in the demodulated signal.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a block diagram of an example through-beam photoelectric sensor that uses light pulse modulation.

FIG. 2 is a block diagram of an example reflective photoelectric sensor that uses light pulse modulation.

FIG. 3 is a block diagram of an example emitter of a through-beam photoelectric sensor that uses single-tone continuous wave modulation.

FIG. 4 is a block diagram of an example receiver of a through-beam photoelectric sensor that uses single-tone continuous wave modulation.

FIG. 5 is a block diagram of a through-beam photoelectric sensor comprising an emitter and receiver that use single-tone continuous wave modulation.

FIG. 6 is a block diagram of a diffuse photoelectric sensor that implements single-tone modulation techniques.

FIG. 7 is a block diagram of a diffuse photoelectric sensor that includes automatic frequency adjustment functionality.

FIG. 8 is a block diagram of a through-beam photoelectric sensor that supports ambient noise detection.

FIG. 9 is a flowchart of an example methodology for emitting a single-tone light beam for a presence-detecting photoelectric sensor.

FIG. 10 is a flowchart of an example methodology for detecting a single-tone light signal projected by an emitter of a photoelectric sensor.

FIG. 11 is a flowchart of an example methodology for automatically adjusting a fundamental frequency of a single-tone optical signal of a photoelectric sensor.

FIG. 12 is an example computing environment.

FIG. 13 is an example networking environment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding thereof. It may be evident, however, that the subject disclosure can be practiced without these specific details. In other instances, well-known structures and devices are shown in block diagram form in order to facilitate a description thereof.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removable affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches also can be used.

Many industrial applications utilize photoelectric sensors to detect presence of objects or people at certain locations around a controlled process or machine. For example, such sensors may be mounted at selected conveyor locations to detect the presence of a part at those locations. Such photoelectric sensors may also be mounted near potentially hazardous moving components of the industrial system to detect human presence at these locations. These sensors typically control a discrete output to a control system (e.g., an industrial controller, a safety relay, etc.) based on detection of an emitted light beam at a receiver.

Different types of photoelectric sensors are available, corresponding to different operating types. For example, through-beam photoelectric sensors comprise a transmitter or emitter component that projects a light beam to a separate receiver component aligned to emitter's line-of-sight. Through-beam photoelectric sensors are generally on-off type sensors that generate a discrete output based on the presence or absence of an object between the emitter and transmitter components. For a normally-on type sensor, the output remains on while the receiver component detects the light beam being sent by the emitter component, and is turned off when the emitter fails to detect the beam, indicating that an obstruction has blocked the beam. For a normally-off type sensor, the output turns on when the beam is obstructed, and remains off while the emitter detects the beam.

Reflective type photoelectric sensors operate on a similar principle; however, rather than comprising physically separate emitter and receiver elements, a reflective photoelectric sensors comprises a single element that houses both the emitter and receiver components. Reflective photoelectric sensors project the light beam toward the detection area, such that objects placed in front of the sensor reflect the beam back to the receiver, causing the sensor to indicate presence at the object.

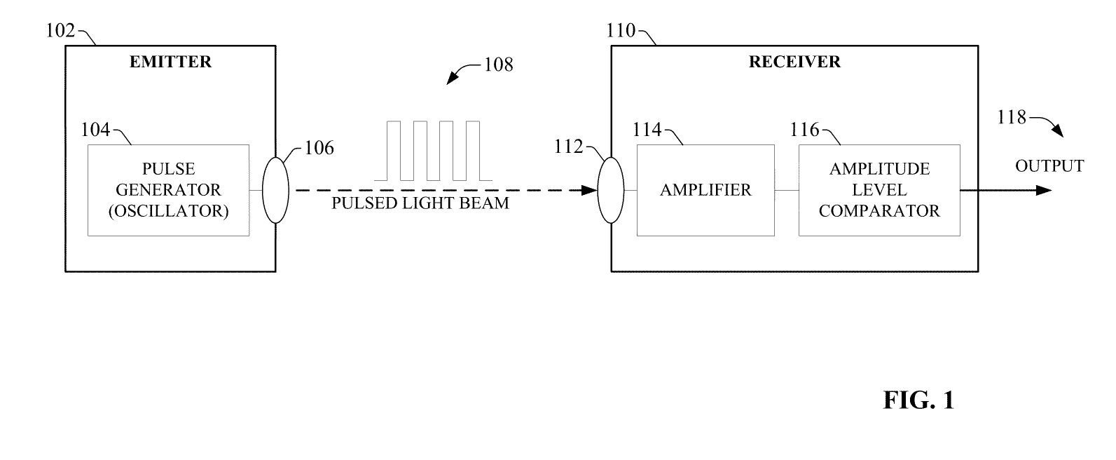

Typically, on-off type photoelectric sensors project light beams using light pulse modulation. FIG. 1 illustrates an example through-beam photoelectric sensor that uses light pulse modulation. Emitter 102 comprises a pulse generator 104 (also referred to as an oscillator) that modulates a light beam into a stream of high-frequency light pulses 108 directed to the receiver 110. The light pulses 108 are projected via a light emitting diode (LED) 106, laser, or other current-driven light source on the emitter 102. By emitting the light beam as a series of pulses, the emitter 102 creates a distinctive light pattern that the receiver can recognize and distinguish from ambient (non-pulsed) light. The receiver 110 receives the pulsed light beam via window 112. The light beam is converted to an electrical signal that is passed through an amplifier 114, and an amplitude level comparator 116 determines whether the magnitude of the amplified signal exceeds a threshold indicating that the light beam was received at window 112. The sensor generates an output 118 based on a result of the comparison. In some sensors, the amplitude level comparator 116 is enabled during a specified time window to confirm proper timing of the pulsed light signal.

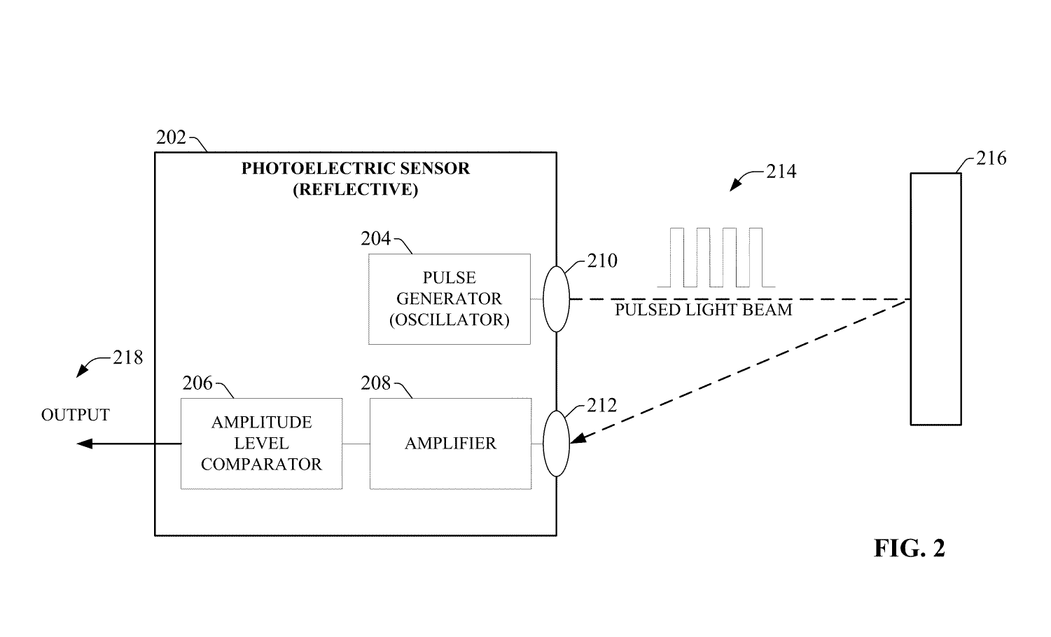

FIG. 2 illustrates an example reflective photoelectric sensor that uses light pulse modulation. Similar to the through-beam sensor described above, photoelectric sensor 202 comprises a pulse generator 204 that projects a pulsed light beam 214 via LED 210. When an object 216 is placed in the sensor's line-of-site within the operating range of the light beam 214, the beam is reflected by the object 216 and the reflected beam is received at window 212. The reflected beam is converted to an electrical signal and amplified by amplifier 208, and amplitude level comparator 206 confirms detection of the reflected beam based on a comparison of the magnitude of the amplified signal with a threshold value. Output 218 is generated based on a result of the comparison.

Since the light pulses protected by the emitter generally comprise a wide frequency spectrum, this pulse modulation detection technique often requires the emitter to generate the pulsed light beam at a high power—sometimes at a power level that exceeds the power specifications of the LED—so that the receiver can more easily distinguish the beam from ambient light and/or sense at a longer distance. Moreover, because the light pulses have a high spectral bandwidth, the receiver must be configured to detect light across this large bandwidth, making the sensor more susceptible to ambient light noise across this detection range.

To address these and other issues, one or more embodiments of this disclosure provide a photoelectric sensor that modulates a light beam using a single-tone continuous wave (e.g., a sine wave, square wave, or triangular wave) rather than a short light pulse having a large bandwidth. Detection of this single-tone signal by the receiver components is based on demodulation and synchronous detection of the fundamental frequency component of this received signal. As a result, the receiver can perform selective, narrow band filtering on the signal around this fundamental signal frequency, thereby achieving a large degree of out-of-band noise rejection.

Moreover, the energy required for generation of the light beam can be optimized and adjusted based on the reception and detection conditions. For identical noise rejection, it has been found that the energy level required for single tone continuous wave modulation is lower than that required for classical pulse modulation.

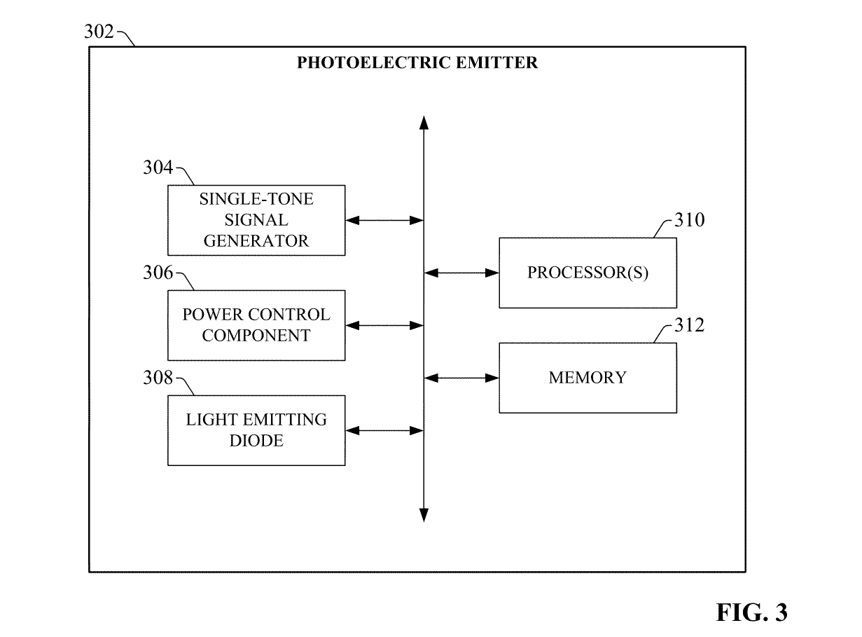

FIG. 3 is a block diagram of an example emitter 302 of a photoelectric sensor according to one or more embodiments of this disclosure. Emitter 302 can be implemented in any suitable type of photoelectric sensor, including but not limited to diffuse, retro-reflective, or through-beam type sensors. Aspects of the systems, apparatuses, or processes explained in this disclosure can constitute machine-executable components embodied within machine(s), e.g., embodied in one or more computer-readable mediums (or media) associated with one or more machines. Such components, when executed by one or more machines, e.g., computer(s), computing device(s), automation device(s), virtual machine(s), etc., can cause the machine(s) to perform the operations described.

Emitter 302 can include a single-tone signal generator 304, a power control component 306, a light emitting diode (LED) 308, one or more processors 310, and memory 312. In various embodiments, one or more of the single-tone signal generator 304, power control component 306, LED 308, the one or more processors 310, and memory 312 can be electrically and/or communicatively coupled to one another to perform one or more of the functions of the emitter 302. In some embodiments, one or more of components 304, 306, or 308 can comprise software instructions stored on memory 312 and executed by processor(s) 310. Emitter 302 may also interact with other hardware and/or software components not depicted in FIG. 3. For example, processor(s) 310 may interact with one or more external user interface devices, such as a keyboard, a mouse, a display monitor, a touchscreen, or other such interface devices. Moreover, the photoelectric sensor may include LED indicators or other types of indicators to convey state information to a user. The photoelectric sensor may also include a communication link (wired or wireless) for communicating such information as an object presence indication, health and/or status information for the sensor, or other such information.

Single-tone signal generator 304 can be configured to generate a single-tone, continuous wave signal used to modulate a light beam projected by the emitter. The single-tone signal generator 304 can generate the continuous wave signal to have a single fundamental frequency, allowing a corresponding receiver of the photoelectric sensor to detect the signal by evaluating a narrow frequency band around the fundamental frequency. In some embodiments, the single-tone signal generator 304 can be configured to emit the continuous wave in bursts in order to reduce power consumption of the sensor, which may be a preferred option for applications in which response time is less critical. Some embodiments of single-tone signal generator 304 can also be configured to combine two or more single tone signals, either together or multiplexed in time. Power control component 306 can be configured to control the power of the generated signal and corresponding light beam. Light-emitting diode (LED) 308 can be configured to emit the light beam in accordance with the modulated continuous wave signal generated by the single-tone signal generator 304.

The one or more processors 310 can perform one or more of the functions described herein with reference to the systems and/or methods disclosed. Memory 312 can be a computer-readable storage medium storing computer-executable instructions and/or information for performing the functions described herein with reference to the systems and/or methods disclosed.

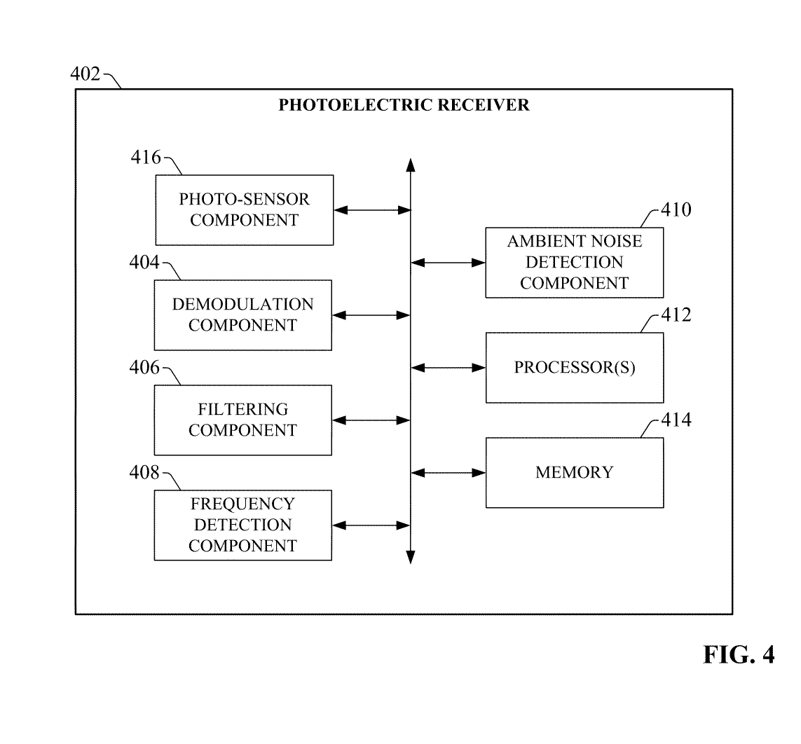

FIG. 4 is a block diagram of an example receiver 402 of a photoelectric sensor according to one or more embodiments of this disclosure. As with emitter 302, receiver 402 can be implemented in any type of photoelectric sensor (e.g., diffuse, retro-reflective, through-beam, etc.).

Receiver 402 can include a photo-sensor component 416, a demodulation component 404, a filtering component 406, a frequency detection component 408, an ambient noise detection component 410, one or more processors 412, and memory 414. For sensors in which emitter 302 and receiver 402 reside in the same housing (e.g., retro-reflective or diffuse sensors), the one or more processors 412 and memory 414 may be the same as processors 310 and memory 312. In various embodiments, one or more of the photo-sensor component 416, demodulation component 404, filtering component 406, frequency detection component 408, ambient noise detection component 410, the one or more processors 412, and memory 414 can be electrically and/or communicatively coupled to one another to perform one or more of the functions of the receiver 402. In some embodiments, one or more of components 416, 404, 406, 408, and 410 can comprise software instructions stored on memory 414 and executed by processor(s) 412. Receiver 402 may also interact with other hardware and/or software components not depicted in FIG. 4. For example, processor(s) 412 may interact with one or more external user interface devices, such as a keyboard, a mouse, a display monitor, a touchscreen, or other such interface devices.

Photo-sensor component 416 can be configured to convert received light incident on a surface of the photo-sensor component to an electrical output proportional to the intensity of the incident light. Demodulation component 404 can be configured to demodulate the electrical signal generated by the photo-sensor component 416 to yield a demodulated electrical signal. Filtering component 406 can be configured to filter the demodulated electrical signal such that only the fundamental frequency of the modulated light beam or a narrow band of frequencies around the fundamental frequency are passed. The frequency detection component 408 can be configured to analyze the filtered signal generated by the filtering component 406 to determine whether the fundamental frequency of the transmitted light beam is present at an expected amplitude, and control an output of the sensor based on presence or absence of the fundamental frequency. Frequency detection component 408 can also be configured to determine the amplitude and phase of the single tone detected within the signal. The ambient noise detection component 410 can be configured to analyze the ambient noise energy spectrum in the environment surrounding the receiver 402 and adjust the fundamental frequency of the emitter's single-tone signal generator to move the fundamental frequency away from the measured noise frequencies. The one or more processors 412 can perform one or more of the functions described herein with reference to the systems and/or methods disclosed. Memory 414 can be a computer-readable storage medium storing computer-executable instructions and/or information for performing the functions described herein with reference to the systems and/or methods disclosed.

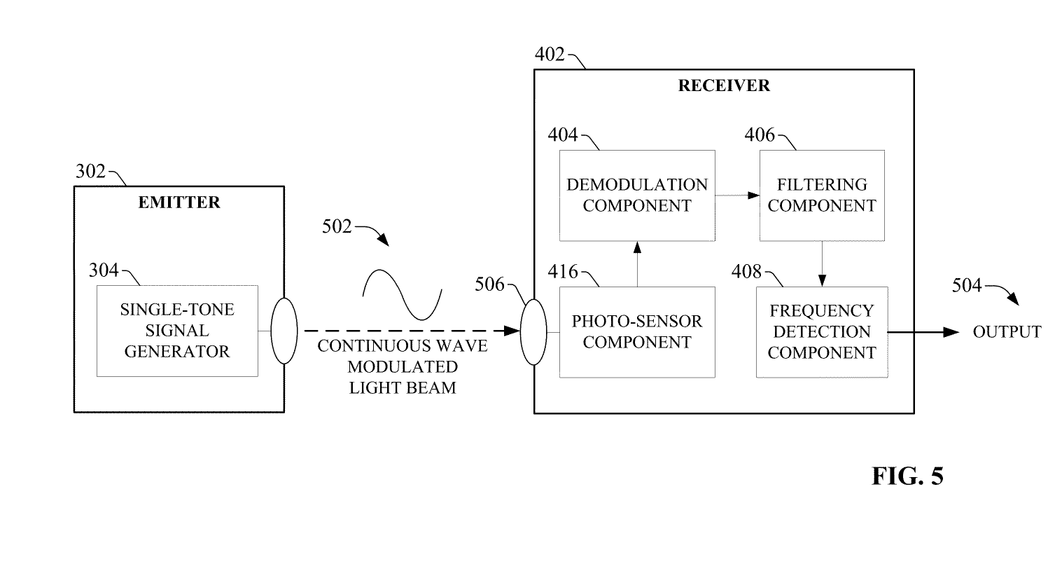

FIG. 5 is a block diagram of a through-beam photoelectric sensor comprising an emitter 302 and receiver 402 that operate in accordance with one or more embodiments of this disclosure. In this example, the photoelectric sensor comprises an emitter 302 and a receiver 402 mounted across from one another such that the receiving element 506 of receiver 402 is aligned to receive a light beam projected by LED 308 of emitter 302. Emitter 302 projects light beam 502 using an LED, laser, remote phosphor, or other such light source. The beam is received at receiving element 506 of receiver 402 and demodulated by demodulation component 404.

Emitter 302 comprises a single-tone signal generator 304, which modulates the light beam generated by the photosensor's light source (e.g., laser, LED, remote phosphor, etc.). Rather than projecting a pulse modulated light beam, single-tone signal generator 304 modulates the light beam using a continuous wave, such as a sine wave, a square wave, or a triangular wave. In contrast to the relatively large bandwidth of light pulses (which depends on the width of the pulses), the continuous wave generated by single-tone signal generator 304 is based on a single tone or fundamental frequency. This allows the receiver 402 to detect the light beam signal by narrowly filtering on the known fundamental frequency, thereby rejecting out-of-band noise at frequencies outside the narrow filtering passband. In some embodiments, the continuous wave may be sent by burst in order to reduce power consumption.

When the single-tone light beam 502 is received at receiving element 506 of receiver 402, photo-sensor component 416 converts the incident light beam to an electrical output, which is demodulated by the demodulation component 404 to yield an electrical signal. In one or more embodiments, demodulation may be implemented using analog functions, or realized in software after analog-to-digital conversion using digital signal processing filtering and detection algorithms. Filtering component 406 selectively filters the electrical signal using a narrow filter bandwidth around the fundamental frequency, using either analog or digital filtering (or a combination of analog and digital filtering). Frequency detection component 408 then examines the filtered signal (e.g., using frequency spectral component analysis) to determine whether the single-tone signal is present at the expected amplitude. The frequency detection component 408 generates an output 504 based on a determination of whether the frequency component of the filtered signal corresponding to the fundamental frequency has a magnitude that exceeds a threshold indicating presence of the signal.

In some embodiments, frequency detection component 408 can additionally determine the phase of the single-tone signal detected in the received light beam, and compare this phase with the phase of the modulated light beam sent by the emitter. This can provide additional confirmation that the received light beam corresponds to the emitted beam, ensuring that ambient light having a similar frequency component as the single-tone of the modulated light beam does not improperly trigger the sensor output. For example, if the frequency detection component 408 determines that the phase of the received light beam is within a defined range of the phase of the emitted light beam (and that the frequency component of the received light beam corresponds to the single-tone of the emitted beam), the photoelectric sensor assumes that the received beam is the reflected beam emitted by the sensor. Alternatively, if the frequency detection component 408 confirms that the frequency component of the received light beam matches the single-tone of the emitted beam, but that the phase of the received beam does not fall within an expected range of the phase of the emitted light beam, the sensor may ignore the received light beam.

Since the single-tone signal generator 304 modulates light beam 502 based on a single-tone continuous wave, the receiver can demodulate and evaluate the received signal within a narrow band around the fundamental frequency of the signal. Since frequencies outside this narrow band are blocked, this technique achieves greater noise immunity relative to light pulse modulation, which requires analysis of a larger bandwidth in order to detect the light pulses. Thus, the photoelectric sensor depicted in FIG. 5 is more robust against external perturbations such as electromagnetic compatibility (EMC) noise or noise from a parasite light source. In some cases, noise immunity may be sufficiently robust that little or no EMC shielding is required. Moreover, generation of the light beam modulated according to a single-tone continuous wave requires less energy relative to light pulse modulation. In some embodiments, the amount of power used to generate the single-tone light beam can be adjusted based on environmental conditions, as will be described in more detail below. In general, single-tone continuous wave modulation requires less energy to achieve a degree of noise rejection comparable to light pulse modulation techniques.

In some embodiments, the continuous wave light beam can be interrupted and sent by burst in order to reduce power consumption, depending on the response time and switching frequency requirements of the sensor. Also, a selective analog filter can be directly implemented on the LED current source or as part of the first amplification stage to prevent saturation of the high gain trans-impedance amplifier.

Although the system of FIG. 5 has been described as modulating light beam 502 based on a continuous wave comprising a single tone, some embodiments of single-tone signal generator 304 may be configured to modulate light beam 502 using multiple tones. In such embodiments, the single-tone signal generator 304 can combine several single-tone signals and modulate light beam 502 using this combined signal. For example, single-tone signal generator 304 may generate the modulation signal by multiplexing two or more single tones in time, or by combining the two or more single tones within a common time frame. In such embodiments, the demodulation, filtering, and frequency detection components of the receiver can be configured to recognize the combined single tones in the received signal. For example, in such embodiments, filtering component 406 may be configured to pass frequencies that include all tones used by the single-tone signal generator 304 to modulate the light beam 502. For signals modulated using time-multiplexed tones, the frequency detection component 408 can be configured to recognize the presence of all modulating tones in the received signal, at the expected time frames relative to one another. Using multiple single-tones within the modulation signal can allow the receiver 402 to more easily and accurately identify receipt of the modulated light beam.

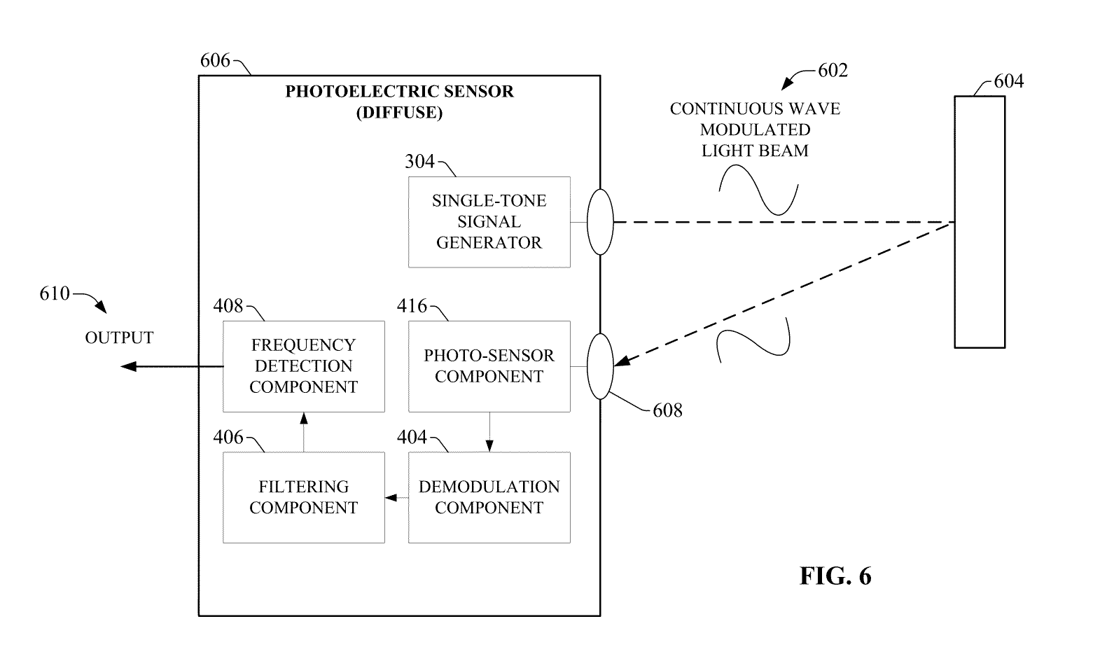

Also, although FIG. 5 illustrates the above-described functionality in connection with a through-beam photoelectric sensor, it is to be appreciated that the single-tone signal generator 304, demodulation component 404, filtering component 406, and frequency detection component 408 can be implemented in other types of photoelectric sensors (e.g., retro-reflective, diffused, etc.). FIG. 6 is a block diagram of a diffuse photoelectric sensor 606 that implements the single-tone generation techniques described above. Since photoelectric sensor 606 is a diffuse sensor, the emitter and receiver components reside in a common housing. Similar to the example depicted in FIG. 5, single-tone signal generator 304 modulates the emitted light beam 602 using a continuous wave. When an object 604 is placed in front of the single-tone light beam 602, the beam is diffused, causing at least a portion of the diffused light beam to be reflected to the receiving element 608 of photoelectric sensor 606. The photo-sensor component 416, demodulation component 404, filtering component 406, and frequency detection component 408 then perform processing on the reflected light beam similar to that described above in connection with FIG. 5 to determine whether the single-tone signal is present in the diffused light beam at the expected amplitude. The frequency detection component 408 generates an output 610 based on a determination of whether the frequency component corresponding to the fundamental frequency of the emitted signal is present in the diffused signal at a magnitude that exceeds a threshold indicating presence of the signal.

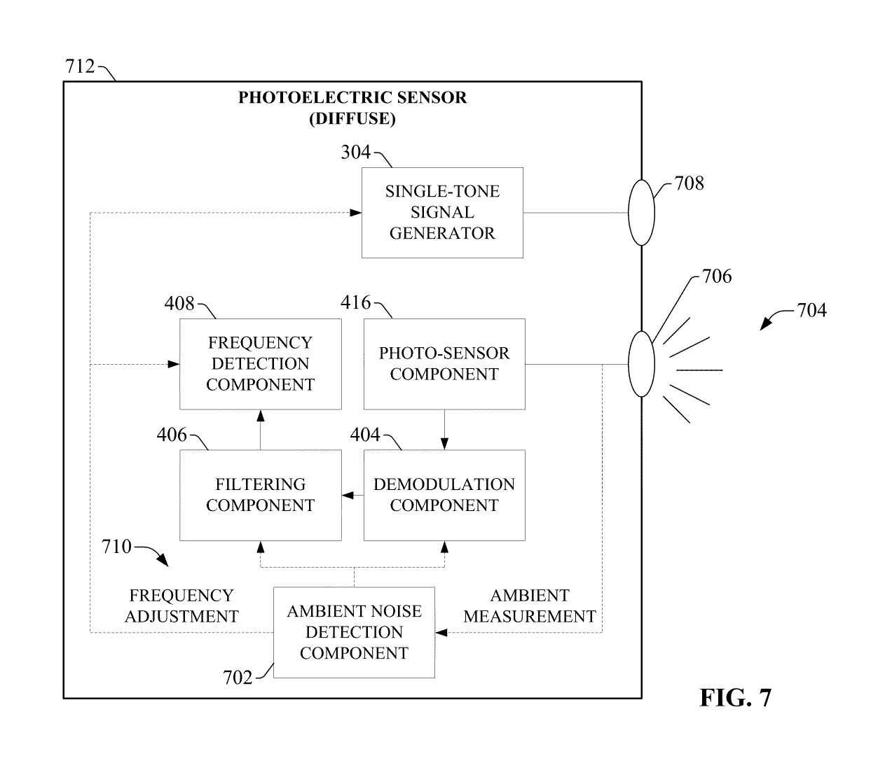

In one or more embodiments, the fundamental frequency of the single-tone signal can be adjusted automatically to ensure that the frequency of the light beam remains spectrally distinct from the ambient noise frequency of the environment in which the photoelectric sensor is mounted. FIG. 7 illustrates a diffuse photoelectric sensor 712 that includes automatic frequency adjustment functionality according to one or more embodiments. As described in previous examples, the photoelectric sensor 712 comprises a single-tone signal generator 304 for modulating an emitted light beam using a continuous-wave, single-tone signal. When the modulated light beam is reflected by an object within the path of the beam, at least a portion of the reflected or diffused light beam is received by receiving element 706 and converted to an electrical output by photo-sensor component 416. The demodulation component 404, filtering component 406, and frequency detection component 408 determine the presence of the reflected light beam by selectively filtering on the fundamental frequency of the modulation signal.

As noted above, by narrowly filtering the received light beam such that only a small bandwidth around the fundamental frequency is passed to the frequency detection component 408, ambient light noise comprising frequencies outside of this narrow bandwidth is effectively filtered by the receiver 402, making detection of the light beam more robust. Since ambient light having frequency components that correspond to the narrow filtering bandwidth of the filtering component 406 may still be passed to the frequency detection component 408, signal detection can be made more reliable by setting the fundamental frequency of the light beam to be outside the frequency band(s) corresponding to ambient light noise surrounding the receiver 402. This would allow the passband of filtering component 406 (that is, the range of frequencies allowed to pass though the filtering component 406) to be placed outside the ambient noise spectrum, ensuring that no ambient noise frequencies are passed to the frequency detection component.

Since the ambient noise frequencies are environment specific (depending on the number, positions, and types of light sources near the receiver 402), one or more embodiments of the photoelectric sensor described herein can include functionality for setting the fundamental frequency of the single-tone signal (and, correspondingly, the passband of the filtering component 406 and detection frequency of frequency detection component 408) based on ambient noise frequencies measured at the receiver 402. To this end, one or more embodiments of receiver 402 can include an ambient noise detection component 702. During a “quiet” period during which the emitting element 708 is not projecting a light beam, the ambient noise detection component 702 can measure and analyze the ambient light received at receiving element 706 to determine one or more characteristics of ambient light noise that can be used to differentiate signal from noise. Once these noise characteristics are identified, the system can adjust the signal based on the measured noise to allow the system to more accurately differentiate signal from noise.

For example, ambient noise detection component 702 can be configured to determine the frequency components of the ambient light noise seen by photo-sensor component 416. Once the frequency bands of the ambient light noise have been detected, the ambient noise detection component 702 can select a noise-free bandwidth (equal in width to the passband of the filtering component 406) that does not overlap with the identified noise bandwidths. The ambient noise detection component 702 can then send a frequency adjustment signal 710 to single-tone signal generator 304 that sets the fundamental frequency of the modulation signal to be at or near the center of this noise-free band. Ambient noise detection component 702 can also re-configure the demodulation component 404, filtering component 406, and frequency detection component 408 accordingly to ensure that those components evaluate the reflected light beam for presence of the modified fundamental frequency. For example, the ambient noise detection component 702 can change the passband of the filtering component 406 to correspond to the new fundamental frequency of the single-tone signal generator 304. The ambient noise detection component 702 can also re-configure the frequency detection component 408 to control the discrete output of the receiver 402 based on a determination of whether the magnitude of the frequency component corresponding to the new fundamental frequency exceeds a threshold indicative of presence of the light beam (as modulated based on the new fundamental frequency).

In some embodiments, the ambient noise detection component 702 can be configured to measure the ambient noise and reconfigure the sensor on demand (e.g., in response to an instruction received from a user via a push button or other triggering means). Alternatively, in some embodiments, the ambient noise measurement and sensor re-configuration sequence can be initiated automatically in response to a defined trigger (e.g., each time the sensor is powered on, at periodic intervals, etc.).

In some embodiments, the ambient noise detection component 702 can also be configured to automatically adjust the power level used to generate the optical signal based on the detection conditions measured at the receiving element 706. For example, the ambient noise detection component 702 may measure the intensity of the ambient light noise seen by the receiver 402, the strength of the light beam received from the emitter (which may be a function of the distance between the emitter and the receiver in the case of through-beam sensors, the distance between the sensor and the reflector in the case of retro-reflective sensors, an amount of pollution in the sensing environment, etc.), or other such conditions at or near the receiver. The ambient noise detection component 702 can then adjust the power control component 306 of the emitter 302 (see FIG. 3) based on one or more of these measurements to ensure that the light beam is received at the receiver 402 with sufficient strength for detection. For example, the receiver 402 may be configured to adjust the power of the generated signal such that the light beam is received at a power level that meets or exceeds a defined threshold. Accordingly, the ambient noise detection component 702 will adjust the signal power at the emitter 302 while the light beam is being projected until the power of the light beam received at the receiver 402 meets or exceeds this defined threshold. Adjustment of the signal power may also be a function of the measured intensity A the ambient light around the receiver.

Although the example noise measurement scenarios described above characterize the ambient noise detection component 702 as measuring the frequency and/or intensity of the ambient light noise, it is to be appreciated that other noise characteristics can be measured by one or more embodiments of the ambient noise detection component 702, including but not limited to phase or amplitude. Depending on the particular noise characteristic being measured, the ambient noise detection component 702 can perform a suitable adjustment to the generated signal based on the measured characteristic in order to more easily distinguish the reflected signal from ambient noise.

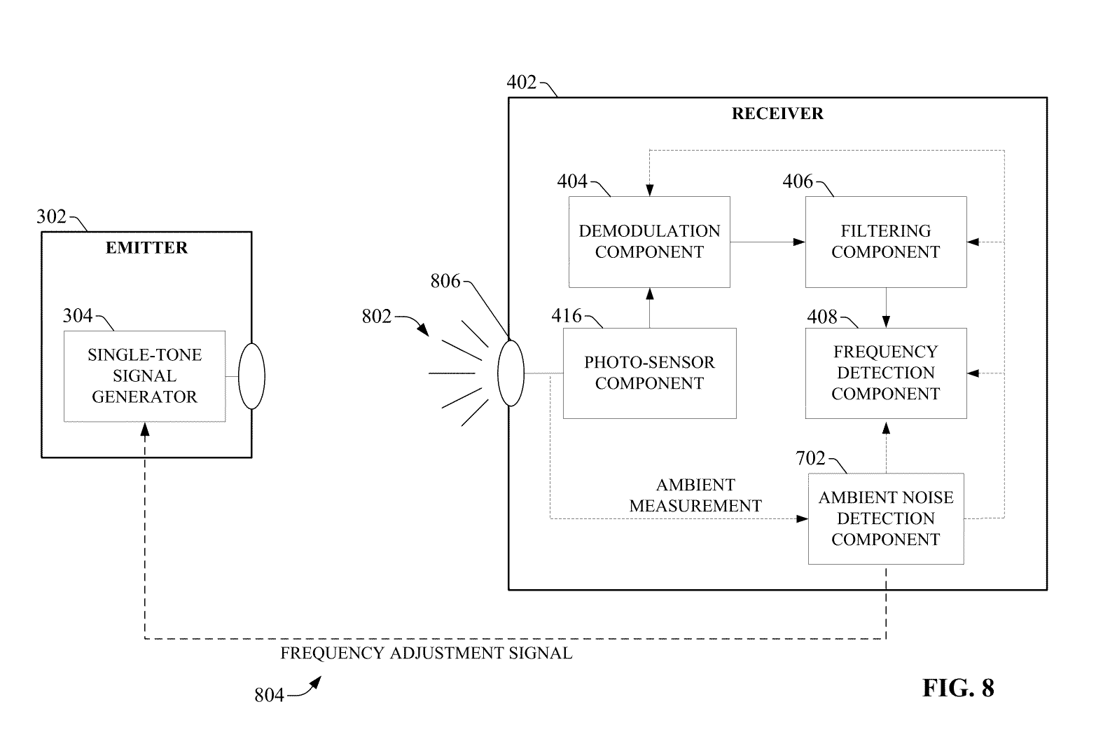

Although the ambient noise detection component 702 is depicted in FIG. 7 as residing in a diffuse photoelectric sensor, it is to be appreciated that the ambient noise measurement and frequency adjustment aspects described above are not limited to such through-beam sensors, and can be incorporated in any suitable type of sensor (e.g., retro-reflective, through-beam, etc.). For example, FIG. 8 illustrates a through-beam photoelectric sensor that incorporates ambient noise detection component 702. In this example, ambient noise detection component 702 performs similar functions to those described above in connection with the diffuse photoelectric sensor of FIG. 7. In particular, ambient noise detection component 702 adjusts the frequency of single-tone signal generator 304 (and re-configures components 404, 406, and 408 accordingly) based on ambient light noise 802 received at receiving element 806 during a period when the emitter 302 is not emitting a light beam to receiver 402. Since the emitter 302 and receiver 402 are physically separated in the through-beam configuration, frequency adjustment signal 804 is sent from the receiver 402 to emitter 302 over a signal line or network connection.

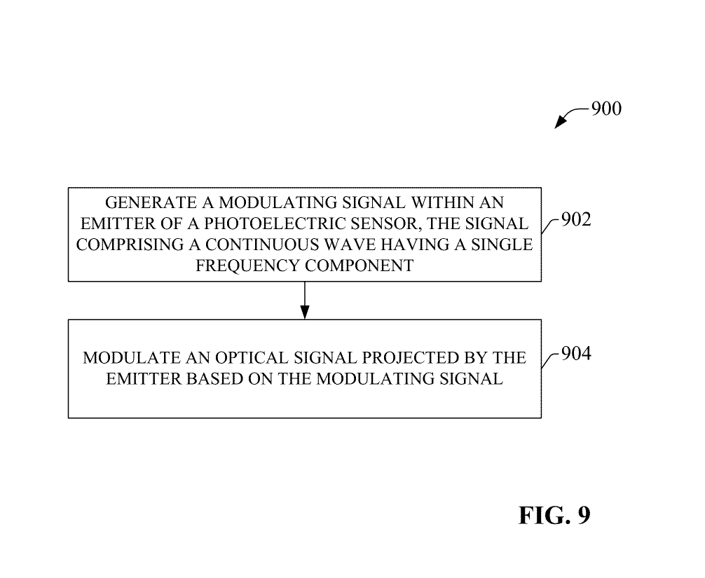

FIGS. 9-11 illustrate various methodologies in accordance with one or more embodiments of the subject application. While, for purposes of simplicity of explanation, the one or more methodologies shown herein are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 9 illustrates an example methodology 900 for emitting single-tone light beam for a presence-detecting photoelectric sensor. Initially, at 902, a modulating signal is generated within an emitter of the photoelectric sensor. The modulating signal comprises a continuous wave having a single frequency component (fundamental frequency). At 904, an optical signal projected by the emitter is modulated based on the modulating signal. By modulating the optical signal based on a continuous wave comprising a single frequency component, the corresponding receiver of the photoelectric sensor can detect the optical signal by narrowly filtering around this single frequency, thereby achieving a high degree of noise rejection and more robust signal detection.

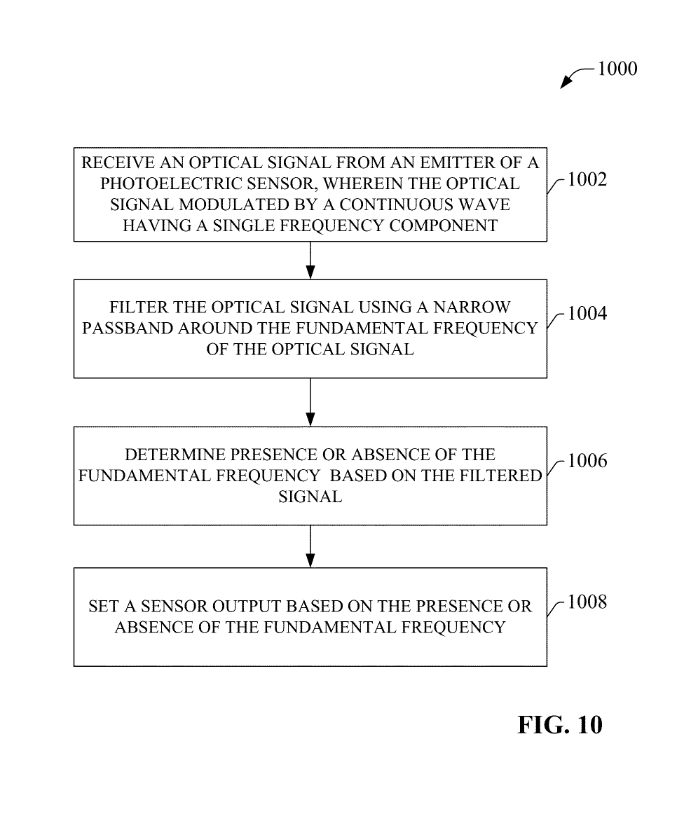

FIG. 10 illustrates an example methodology 1000 for detecting a single-tone light signal projected by an emitter of a photoelectric sensor. Initially, at 1002, an optical signal is received from an emitter of a photoelectric sensor. The optical signal is modulated by a single-tone continuous wave having a single frequency component. At 1002, the optical signal is filtered based on a narrow passband around the fundamental frequency of the optical signal. Since the optical signal is modulated using a single tone (fundamental frequency), a narrow bandwidth around this known frequency of the optical signal can be used to filter the optical signal, thereby rejecting ambient noise frequencies outside this narrow bandwidth.

At 1006, the presence or absence of the fundamental frequency of the optical signal is determined based on evaluation of the filtered signal. For example, the presence of the fundamental frequency may be determined by measuring the magnitude of the signal's frequency component corresponding to the known fundamental frequency of the optical signal. If this magnitude is equal to or greater than a threshold value indicative of the presence of the optical signal, the presence of the fundamental frequency (and therefore the optical signal) is confirmed. At 1008, a sensor output is set based on the determined presence or absence of the fundamental frequency in the filtered signal. For normally-on sensors, the output may be set while the optical signal is detected, and will be turned off when the optical signal is blocked or removed. For normally-off sensors, the output may remain off while the optical signal is detected, and will be turned on when the optical signal is blocked or removed.

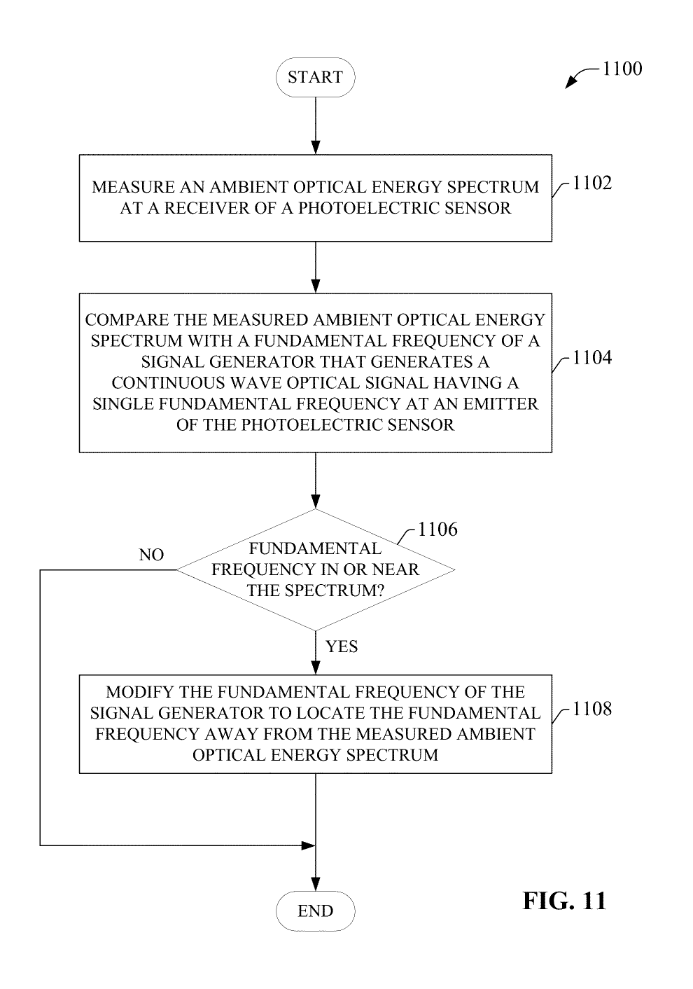

FIG. 11 illustrates an example methodology 1100 for automatically adjusting a fundamental frequency of a single-tone optical signal of a photoelectric sensor. Initially, at 1102, an ambient optical energy spectrum is measured at a receiver of a photoelectric sensor. The measurement is performed while the emitter of the photoelectric sensor is silent (not projecting a light beam to the receiver). The ambient spectrum may comprise light from one or more light sources detected at the receiver, such as fluorescent or other types of artificial lighting, natural light, etc. The frequency components of this measured ambient light are identified, and these identified frequency components collectively comprise the ambient noise spectrum detected at the receiver.

At 1104, the measured ambient optical energy spectrum is compared with the fundamental frequency configured for a single-tone signal generator of the emitter. The single-tone signal generator modulates the photoelectric sensor's light beam using a continuous wave signal comprising a single fundamental frequency. Since the receiver will filter this single-tone optical signal based on a passband centered on the fundamental frequency, the fundamental frequency should be set to be outside the ambient optical energy spectrum, so that ambient optical noise frequencies will not be passed by the filter.

At 1106, a determination is made regarding whether the fundamental frequency of the signal generator is in or near the measured ambient optical energy spectrum. If the fundamental frequency does not overlap with the measured ambient spectrum, no change is made to the fundamental frequency and the methodology ends. Alternatively, if the fundamental frequency is determined to overlap with a portion of the measured ambient spectrum (or if the fundamental frequency is determined to be less than a defined spectral distance from one or more frequency components of the ambient noise), the methodology moves to step 1108, where the fundamental frequency of the signal generator is modified to place the fundamental frequency away from the measured ambient spectrum. For example, since the receiver's filtering component 406 configured with an adjustable passband centered or substantially centered around the continuous wave signal used by the single-tone signal generator to modulate the emitted light beam, the fundamental frequency may be set to a frequency that ensures that none of the ambient optical frequencies will be passed by the filter's passband when the passband is centered at the new fundamental frequency. This can be determined, for example, by calculating the maximum and minimum passband thresholds (where the maximum passband threshold is equal to the new fundamental frequency plus half of the filter bandwidth, and the minimum passband threshold is equal to the new fundamental frequency minus half of the filter bandwidth), and verifying that none of the ambient light frequencies fall within the range between the maximum and minimum filter passband thresholds.

Embodiments, systems, and components described herein, as well as industrial control systems and industrial automation environments in which various aspects set forth in the subject specification can be carried out, can include computer or network components such as servers, clients, programmable logic controllers (PLCs), automation controllers, communications modules, mobile computers, wireless components, control components and so forth which are capable of interacting across a network. Computers and servers include one or more processors—electronic integrated circuits that perform logic operations employing electric signals—configured to execute instructions stored in media such as random access memory (RAM), read only memory (ROM), a hard drives, as well as removable memory devices, which can include memory sticks, memory cards, flash drives, external hard drives, and so on.

Similarly, the term PLC or automation controller as used herein can include functionality that can be shared across multiple components, systems, and/or networks. As an example, one or more PLCs or automation controllers can communicate and cooperate with various network devices across the network. This can include substantially any type of control, communications module, computer, Input/Output (I/O) device, sensor, actuator, and human machine interface (HMI) that communicate via the network, which includes control, automation, and/or public networks. The PLC or automation controller can also communicate to and control various other devices such as standard or safety-rated I/O modules including analog, digital, programmed/intelligent I/O modules, other programmable controllers, communications modules, sensors, actuators, output devices, and the like.

The network can include public networks such as the internet, intranets, and automation networks such as control and information protocol (CIP) networks including DeviceNet, ControlNet, and Ethernet/IP. Other networks include Ethernet, DH/DH+, Remote I/O, Fieldbus, Modbus, Profibus, CAN, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

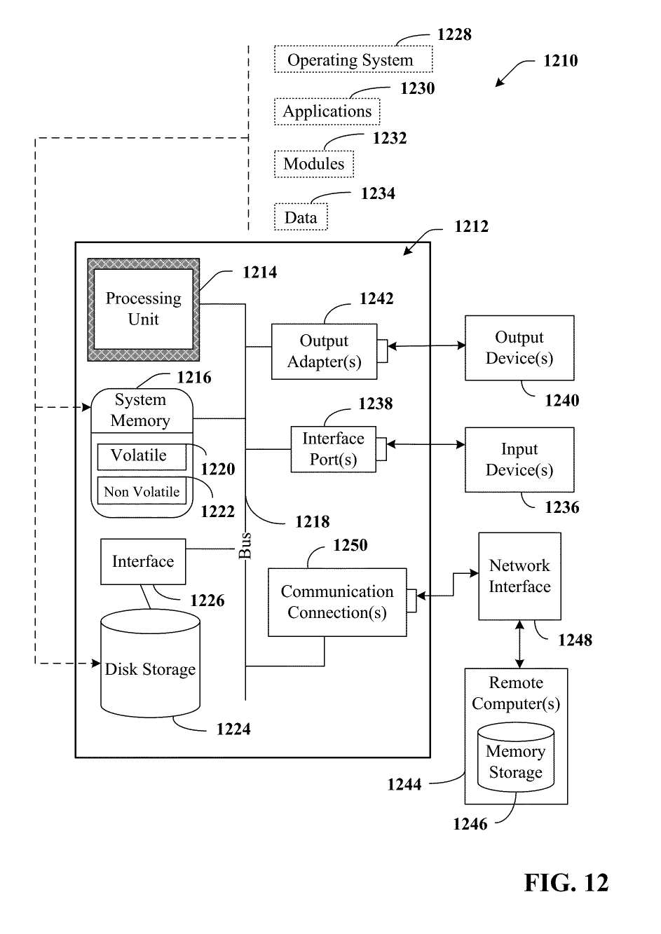

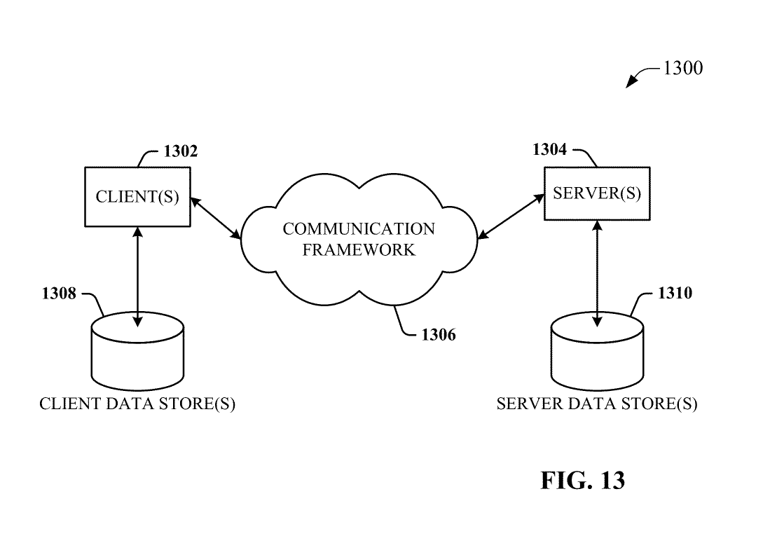

In order to provide a context for the various aspects of the disclosed subject matter, FIGS. 12 and 13 as well as the following discussion are intended to provide a brief, general description of a suitable environment in which the various aspects of the disclosed subject matter may be implemented.

With reference to FIG. 12, an example environment 1210 for implementing various aspects of the aforementioned subject matter includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Multi-core microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable PROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/non-removable, volatile/non-volatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1224 to the system bus 1218, a removable or non-removable interface is typically used such as interface 1226.

It is to be appreciated that FIG. 12 describes software that acts as an intermediary between users and the basic computer resources described in suitable operating environment 1210. Such software includes an operating system 1228. Operating system 1228, which can be stored on disk storage 1224, acts to control and allocate resources of the computer 1212. System applications 1230 take advantage of the management of resources by operating system 1228 through program modules 1232 and program data 1234 stored either in system memory 1216 or on disk storage 1224. It is to be appreciated that one or more embodiments of the subject disclosure can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapters 1242 are provided to illustrate that there are some output devices 1240 like monitors, speakers, and printers, among other output devices 1240, which require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the system bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

FIG. 13 is a schematic block diagram of a sample computing environment 1300 with which the disclosed subject matter can interact. The sample computing environment 1300 includes one or more client(s) 1302. The client(s) 1302 can be hardware and/or software (e.g., threads, processes, computing devices). The sample computing environment 1300 also includes one or more server(s) 1304. The server(s) 1304 can also be hardware and/or software (e.g., threads, processes, computing devices). The servers 1304 can house threads to perform transformations by employing one or more embodiments as described herein, for example. One possible communication between a client 1302 and servers 1304 can be in the form of a data packet adapted to be transmitted between two or more computer processes. The sample computing environment 1300 includes a communication framework 1306 that can be employed to facilitate communications between the client(s) 1302 and the server(s) 1304. The client(s) 1302 are operably connected to one or more client data store(s) 1308 that can be employed to store information local to the client(s) 1302. Similarly, the server(s) 1304 are operably connected to one or more server data store(s) 1310 that can be employed to store information local to the servers 1304.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

1. A photoelectric sensor, comprising:
a single-tone signal generator configured to modulate a light beam based on a single-tone continuous wave signal having a fundamental frequency to yield a modulated light beam, and to emit the modulated light beam in bursts;
a receiver configured demodulate the modulated light beam to yield a demodulated signal and to control an output based on detection of the fundamental frequency in the demodulated signal; and
an ambient noise detection component configured to measure an ambient light noise frequency at the receiver, and to set the fundamental frequency of the single-tone continuous wave signal based at least in part on the ambient light noise frequency measured at the receiver.

2. The photoelectric sensor of claim 1, wherein the receiver comprises a filtering component configured to filter the demodulated signal based on a passband centered or substantially centered on the fundamental frequency of the single-tone continuous wave signal to yield a filtered signal.

3. The photoelectric sensor of claim 2, wherein the receiver further comprises a frequency detection component configured to detect, within the filtered signal, a magnitude of a frequency component corresponding to the fundamental frequency of the single-tone continuous wave signal.

4. The photoelectric sensor of claim 3, wherein the frequency detection component is further configured to control the output based on a determination of whether the magnitude of the frequency component is equal to or greater than a defined threshold magnitude.

5. The photoelectric sensor of claim 1, wherein the single-tone continuous wave signal comprises at least one of a sine wave, a triangular wave, or a square wave.

6. The photoelectric sensor of claim 4, wherein the single-tone continuous wave signal is a first single-tone continuous wave signal, and the single-tone signal generator is configured to combine the first single-tone continuous wave signal and a second single-tone continuous wave signal having different fundamental frequency than the first single-tone continuous wave signal to yield a combined signal, and to modulate the light beam based on the combined signal.

7-8. (canceled)

9. The photoelectric sensor of claim 1, wherein the ambient noise detection component is further configured to set a power level of the modulated light beam based at least in part on a measured magnitude of ambient light noise measured by the ambient noise detection component.

10. A method for operating a photoelectric sensor, comprising:
modulating, by an emitter of a photoelectric sensor, a light beam with a single-tone continuous wave signal comprising a fundamental frequency to yield a modulated light beam;
emitting the modulated light beam as a series of bursts;
demodulating the modulated light beam at a receiver of the photoelectric sensor to yield a demodulated signal;
detecting, by a receiver of the photoelectric sensor, presence of the fundamental frequency in the demodulated signal;
controlling an output of the photoelectric sensor based on the detecting;
measuring an ambient light noise frequency spectrum detected at the receiver; and
adjusting the fundamental frequency of the single-tone continuous wave signal based at least in part on the ambient light noise frequency spectrum detected at the receiver.

11. The method of claim 10, wherein the detecting comprises filtering the demodulated signal according to a passband centered or substantially centered on the fundamental frequency of the single-tone continuous wave signal to yield a filtered signal.

12. The method of claim 11, wherein the detecting further comprises analyzing the filtered signal to determine a magnitude of a frequency component corresponding to the fundamental frequency of the single-tone continuous wave signal.

13. The method of claim 12, wherein the controlling comprises:
determining whether the magnitude of the frequency component is equal to or greater than a defined threshold magnitude; and
controlling the output based on a result of the determining.

14. The method of claim 10, wherein the modulating comprises modulating the light beam with at least one of a sine wave, a triangular wave, or a square wave.

15-16. (canceled)

17. The method of claim 10, further comprising adjusting a power level of the light beam based at least in part on the ambient light noise frequency spectrum detected at the receiver.

18. A system for optical detection of objects, comprising:
means for generating a single-tone continuous wave signal comprising a fundamental frequency;
means for modulating a light beam of an emitter of a photoelectric sensor using the single-tone continuous wave signal to generate a modulated light beam;
means for emitting the modulated light beam in bursts;
means for demodulating the modulated light beam at a receiver of the photoelectric sensor to yield a demodulated signal;
means for controlling an output of the photoelectric sensor based on detection of the fundamental frequency in the demodulated signal;
means for measuring an ambient light noise frequency spectrum detected at the means for demodulating; and
means for modifying the fundamental frequency of the single-tone continuous wave signal based at least in part on an identified frequency present in the ambient light noise frequency spectrum.

19. The system of claim 18, wherein the single-tone continuous wave signal comprises at least one of a sinusoidal wave, a triangular wave, or a square wave.

20. The system of claim 18, further comprising
means for filtering the demodulated signal based on a passband centered or substantially centered around the fundamental frequency to yield a filtered signal; and
means for measuring a magnitude of a frequency component of the filtered signal corresponding to the fundamental frequency.

21. The photoelectric sensor of claim 6, wherein the single-tone signal generator is configured to at least one of multiplex the first single-tone continuous wave signal and the second single-tone continuous wave signal in time to yield the combined signal, or to combine the first single-tone continuous wave signal and the second single-tone continuous wave signal within a common time frame to yield the combined signal.

22. The photoelectric sensor of claim 1, wherein the receiver is further configured to determine a first phase of the demodulated signal, and to control the output further based on a determination regarding whether the first phase of the modulated signal corresponds to a second phase of the single-tone continuous wave signal.

23. The photoelectric sensor of claim 1, wherein the ambient noise detection component configured to set the fundamental frequency of the single-tone continuous wave signal to be outside a measured frequency band corresponding to ambient light noise measured at the receiver.

24. The method of claim 10, further comprising:
determining a first phase of the demodulated signal; and
comparing the first phase of the demodulated signal with a second phase of the single-tone continuous wave signal,
wherein the controlling comprises controlling the output further based on a result of the comparing.
